(19) United States
(12) Patent Application Publication
(10) Pub. No.: US 2006/0197850 A1
(43) Pub. Date: Sep. 7, 2006

(54) Camera data transfer system

(75) Inventors: Hiroki Goko, Tokyo (JP); Kenichi Shindate, Tokyo (JP); Shinya Hirasaki, Tokyo (JP); Junichi Tamura, Tokyo (JP)

Correspondence Address: NIXON PEABODY, LLP, 401 9TH STREET, NW, SUITE 900, WASHINGTON, DC, 20004-2128, US

(73) Assignee: Oki Electric Industry Co., Ltd., Tokyo (JP)

(21) Appl. No.: 11/239,009

(22) Filed: Sep. 30, 2005

(30) Foreign Application Priority Data
Mar. 1, 2005 (JP) 2005-056143

(51) Int. Cl. H04N 5/76

(52) U.S. Cl. 348/231.99

(57) ABSTRACT

The present invention provides a camera data transfer system comprising an imaging means for generating image data and outputting the same, and a camera interface means including a first holding means for holding one frame-preceding image data, a second holding means for holding the present image data, a comparing means for comparing the contents of the first and second holding means, and a bus interface means for controlling the input/output of data to and from a bus. In the camera data transfer system, the data is transferred to a frame memory of a display means connected to the bus through the bus interface means to cause the frame memory to display the data thereon. Further, when the data held in the first holding means and the data held in the second holding means are found not to coincide with each other as the result of comparison by the comparing means, only a place corresponding to the inconsistent data is transferred to the frame memory of the display means, and the data at the corresponding place of the first holding means is rewritten.

### BACKGROUND OF THE INVENTION

The present invention relates to a camera data transfer system which transfers image data outputted from a camera module to an external memory and an LCD or the like through a data bus, and particularly to a camera interface suitable for use in a camera data transfer system, which transfers data outputted from a camera module to a bus.

FIG. 8 is a diagram showing a schematic configuration illustrative of a conventional cameral interface and its peripheral devices. This system is provided with a camera module 101 equipped with a lens, which generates image data and outputs the same therefrom. The image data are outputted in the form of 8-bit data expressed in a RGB or YUV format in the main. The present system is further equipped with a camera interface (102), which is provided thereinside with an image data capture circuit (103) which captures the image data sent from the camera module (101), a memory (104) such as an FIFO which temporarily stores the image data therein, an FIFO control circuit (105) and a bus interface circuit (106).

The output (107) of a camera interface is connected to a bus (108). A data width of each image data is made coincident with a bit width of the bus,.and the image data is transferred to a RAM (110) and subjected to JPEG compression processing by, for example, a CPU (114) or the like as a still image or picture. Also the image data is transferred to an LCD display unit (111) and temporarily stored in a frame memory (112), followed by being displayed on a display panel (113) as a motion picture. One including the LCD display unit including the frame memory that holds the input image data therein, and the display panel is called “LCD display unit”.

When the bus (108) is used by bus masters such as the CPU (114) and a DMA control circuit (109), a bus arbiter (115) arbitrates bus-use rights.

The above has been disclosed in Japanese Patent Laid-Open No. Hei 9(1997)-159993.

In the case of representation of a motion picture, the size and frame rate (corresponding to the number of frames represented for one second) of a displayable motion picture is principally determined according to bus transfer capability. In the conventional LCD display unit, all data corresponding to one frame have been transmitted and represented every frames. Thus, a problem arises in that the rate of transfer of data increases in particular upon motion picture representation, the quality of the motion picture is restricted by the bus transfer capability, and power consumption with data transfer increases.

### SUMMARY OF THE INVENTION

With the foregoing in view, it is therefore an object of the present invention to allow a reduction in power consumption by reducing a data transfer rate at the display of a motion picture.

According to a first aspect of the present invention, for attaining the above object, there is provided a camera data transfer system comprising imaging means for generating image data and outputting the same, and camera interface means including first holding means for holding one frame-preceding image data, second holding means for holding the present image data, comparing means for comparing the contents of the first and second holding means, and bus interface means for controlling the input/output of data to and from a bus, wherein the data is transferred to a frame memory of display means connected to the bus through the bus interface means to cause the frame memory to display the data thereon, and wherein when the data held in the first holding means and the data held in the second holding means are found not to coincide with each other as the result of comparison by the comparing means, only a place corresponding to the inconsistent data is transferred to the frame memory of the display means, and the data at the corresponding place of the first holding means is rewritten.

According to a second aspect of the present invention, the camera interface means is further provided with memory access monitor means and the memory access monitor means is configured so as to compare the number of rewritings for the first holding means with a predetermined threshold value and output information corresponding to the result of comparison to the bus.

According to a third aspect of the present invention, the camera interface means further includes mask setting means, which selects the contents of the first holding means and data to be compared of the second holding means in accordance with mask data set to the mask setting means.

According to a fourth aspect of the present invention, the comparing means is configured as means for comparing the contents of the first holding means and the data outputted from the imaging means. Only when inconsistency exists in the data indicative of the result of comparison, the comparing means stores the corresponding inconsistent data and related data in the second holding means.

According to the first aspect of the invention, the contents of the frame memory corresponding to the first holding means and the contents of an FIFO corresponding to the second holding means are compared with each other, and only the inconsistent data is transferred to the frame memory of the display means via the bus. Therefore, the rate of transfer of the data on the bus is reduced. Since the frequency of access to the frame memory of the display means is reduced, power consumption can be reduced.

According to the second aspect of the invention, the frequency of rewriting of the frame memory corresponding to the first holding means is measured and information corresponding to its frequency can be outputted to the bus. Therefore, in addition to an effect obtained according to the first aspect of the invention, an advantageous effect is obtained that since the magnitude of a difference between frames can be determined, information about the difference can be notified to a user by displaying it on the display means and is usable even for an application for controlling shutter timing of the imaging means.

According to the third aspect of the invention, the contents of the first holding means and the data intended for comparison, of the second holding means can be selected in accordance with the information set to the mask setting means. As to UV data lowly sensitive to human eyes like YUV-format data, lower bits can be masked and used for comparison. A further reduction in power consumption can be achieved as compared with the rewriting of all bit-width data.

According to the fourth aspect of the invention, the comparing means compares the contents of the first holding means and the data outputted from the imaging means. Only when they are found to be different, the result of comparison is stored in the FIFO corresponding to the second holding means together with related data. Therefore, an advantageous effect is brought about in that a further reduction in power consumption can be achieved with respect to the first aspect of the invention.

### BRIEF DESCRIPTION OF THE DRAWINGS

While the specification concludes with claims particularly pointing out and distinctly claiming the subject matter which is regarded as the invention, it is believed that the invention, the objects and features of the invention and further objects, features and advantages thereof will be better understood from the following description taken in connection with the accompanying drawings in which:

FIG. 1 is a block diagram schematically showing a configuration of a camera data transfer system according to a first embodiment of the present invention;

FIG. 2 is a block diagram schematically illustrating a configuration of a camera data transfer system according to a second embodiment of the present invention;

FIG. 3 is a diagram depicting one example of an internal configuration of a memory access monitor circuit (319);

FIG. 4 is a block diagram schematically showing a configuration of a camera data transfer system according to a third embodiment of the present invention;

FIG. 5 is a diagram showing one example illustrative of masked data sections in a data comparator employed in the third embodiment;

FIG. 6 is a diagram showing one example illustrative of masked data sections in a data comparator employed in a fourth embodiment of the present invention;

FIG. 7 is a diagram illustrating a specific example of a data configuration of an FIFO employed in the fourth embodiment; and

FIG. 8 is a diagram showing a schematic configuration illustrative of a conventional camera interface and its peripheral devices.

### DETAILED DESCRIPTION OF THE PREFERRED EMBODIMENTS

Preferred embodiments of the present invention will hereinafter be described with reference to the accompanying drawings. Incidentally, the respective figures are merely approximate illustrations to enable an understanding of the present invention.

### First Preferred Embodiment

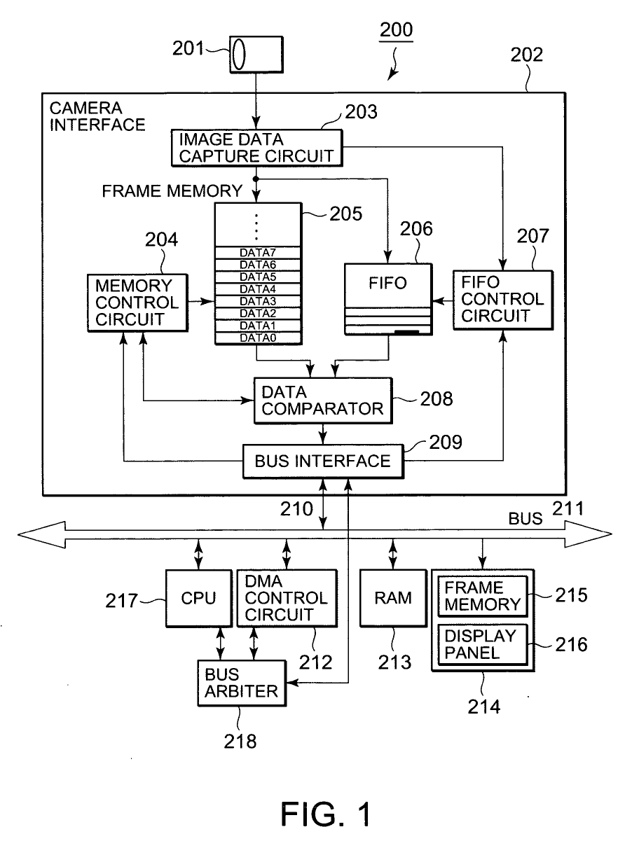

FIG. 1 is a block diagram schematically showing a configuration of a camera data transfer system according to a first embodiment of the present invention. The present camera data transfer system 200 is equipped with a camera interface (202). The camera interface is provided with an image data capture circuit (203) which captures image data transmitted from a camera module (201) of which the outputs are connected to a frame memory (205) that holds image data corresponding to one frame therein, and an FIFO (206) that temporarily holds image data therein.

The one frame-preceding image data are stored in the frame memory. The frame memory and the FIFO are respectively controlled by a memory control circuit (204) and an FIFO control circuit (207). The output of the frame memory and the output of the FIFO are respectively connected to a data comparator (208) of which the outputs are connected to the memory control circuit (204) and a bus interface circuit (209).

The bus interface circuit (209) outputs a transfer destination address, a write enable signal, etc. as well as transfer data while performing swapping with a bus arbiter (218). That is, the camera interface is also provided with a function operated as a bus master.

Image data inputted from the camera module (201) is temporarily stored in the FIFO by the FIFO control circuit (207) via the image data capture circuit (203). One frame-preceding data are all stored in the frame memory (205). At this time, bit connecting or combination, bit separation and the like may be performed according to bit widths of the frame memory and FIFO. The bit widths at this time are determined according to a system like a generally-used bus width or the like.

When a bus-use right for the camera interface is given from the bus arbiter (218), the bus interface circuit (209) issues a read enable signal to the memory control circuit (204) and the FIFO control circuit (207), where data are respectively read from the frame memory (205) and the FIFO (206). At this time, the memory control circuit controls addresses therefor in such a manner that they read the same data as the data read from the FIFO. The same data described herein indicate one frame-preceding data at the same positions (in the order or sequence as viewed from the first data of the frame). Address control at this time is carried out in the following manner, for example. Addresses are sequentially incremented from the first data of the frame to the final data thereof, and when the last address of the frame is reached, each of them may be reset to an address initial value.

The data read from the frame memory (205) and FIFO (206) are transferred to the data comparator (208) and at the same time sequence (address) information in the frames of the data is also transferred to the data comparator. When a mismatch between the two data is detected by the data comparator, addresses at that time and data outputted from the FIFO are sent to the bus interface circuit (209), followed by being transferred to the corresponding addresses of a frame memory (215) in an LCD display unit (214). At the same time, the data comparator (208) transmits a write enable signal to the memory control circuit so that the data at the corresponding addresses in the frame memory are also updated to the data outputted from the FIFO.

The data of the frame memory (205) in the camera interface (202) can also be transferred to a RAM (213).

According to the first embodiment as described above, one frame-preceding data and data in the present frame are compared. only data at discrepant addresses are transferred to a bus, followed by being transferred to the frame memory in the LCD display unit. Consequentially, the rate of transfer of data on the bus and the frequency of access to the frame memory of the LCD display unit are reduced and hence a reduction in power consumption can be expected. Since the data of the frame memory in the camera interface can be transferred to the RAM regardless of the input of data on the cameral module side, the shortening of a data transfer time corresponding to one frame can be expected.

### Second Preferred Embodiment

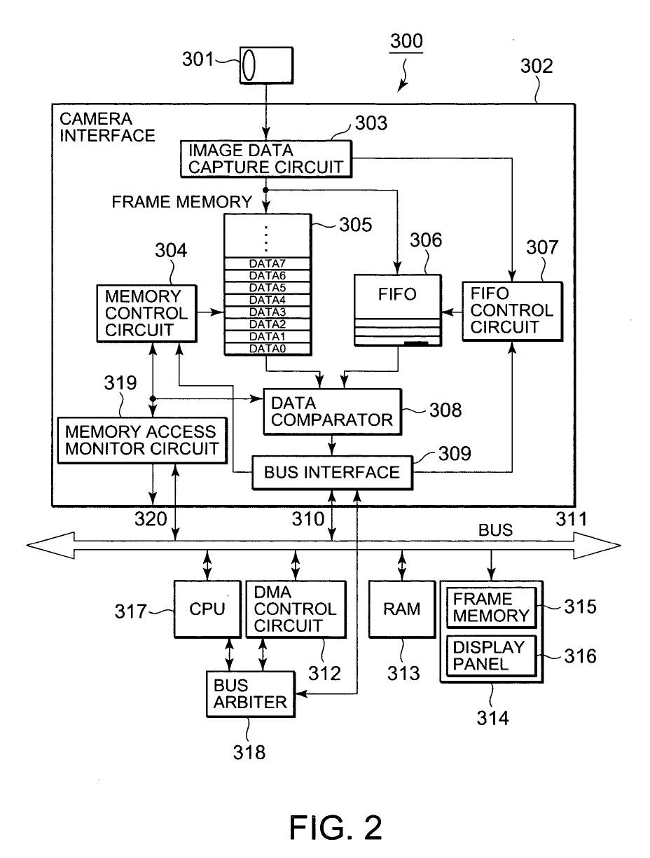

FIG. 2 is a block diagram schematically showing a configuration of a camera data transfer system according to a second embodiment of the present invention. The camera data transfer system (300) is provided with a memory access monitor circuit (319) in addition to the configuration of the first embodiment.

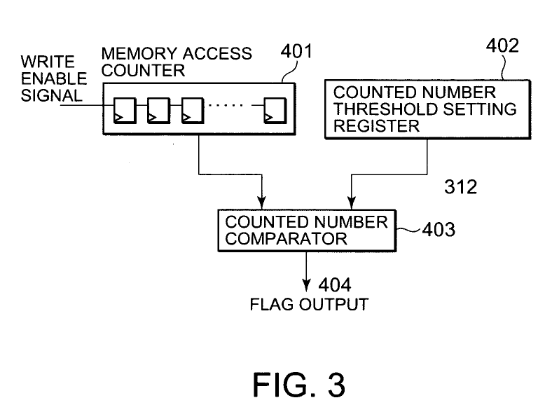

FIG. 3 is a diagram showing one example of an internal configuration of the memory access monitor circuit (319). The present monitor circuit is provided with a memory access counter 401 having the function of inputting a write enable signal outputted from a data comparator (308) and counting the number of accesses to a frame memory during a past given cycle. The present counter can be simply constituted of a shift register or the like. The memory access monitor circuit is further provided with a counted number threshold setting register 402. Writing can be effected on the present register via a bus.

The outputs of the memory access counter (401) and the counted number threshold setting register (402) are inputted to a counted number comparator (403). A flag (404) is outputted from the counted number comparator. The flag is outputted from an external terminal of a camera interface to the outside.

The operation of the camera data transfer system according to the second embodiment will be explained below. The camera data transfer system according to the present embodiment is operated in such a manner that in addition to the operation described in the first embodiment, the memory access monitor circuit (319) monitors the frequency of access to the frame memory and outputs a flag according to the result of its monitoring.

This will be explained below specifically. In FIG. 2, the write enable signal to the frame memory, which has been outputted from the data comparator (308), is simultaneously transferred even to the memory access counter (401) in the memory access monitor circuit (319). The memory access counter counts how many times the write enable signal is made effective or writing is effected on the frame memory during a past given cycle.

The number counted here and the threshold value set by the counted number threshold setting register (402) are compared by the counted number comparator (403). When the counted value is smaller than the threshold value, the counted number comparator (403) outputs flag data therefrom.

According to the second embodiment, the magnitude of a difference between frames can be determined by monitoring the number of accesses to a memory, i.e., the frequency of access to a frame memory during a past given cycle, in addition to the advantageous effect described in the first embodiment. When the difference between the frames is small, it means that the motion of a subject is slow. Therefore, a shake-reduced still picture can be photographed or imaged by a method such as notification of a flag outputted where the magnitude of the difference is smaller than a register setting, to a camera user through an LED or a display panel as the timing provided to depress a shutter, or automatic depression of a shutter depending upon a user setting.

### Third Preferred Embodiment

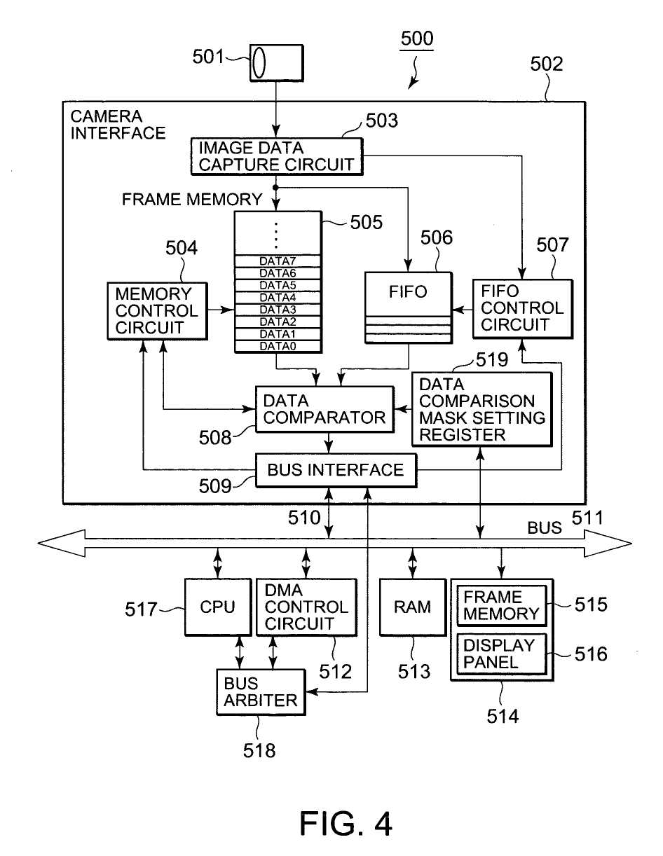

FIG. 4 is a block diagram schematically showing a configuration of a camera data transfer system according to a third embodiment of the present invention. The present camera data transfer system (200) is provided with a data comparison mask setting register (519) in addition to the configuration of the first embodiment. The outputs of the data comparison mask setting register are connected to a data comparator (508) and a bus (511). A bit width of the data comparison mask setting register is identical to the frame memory and FIFO. The value of the data comparison mask setting register can be set via the bus (511). A bus interface circuit 509 has the function of outputting a byte write signal.

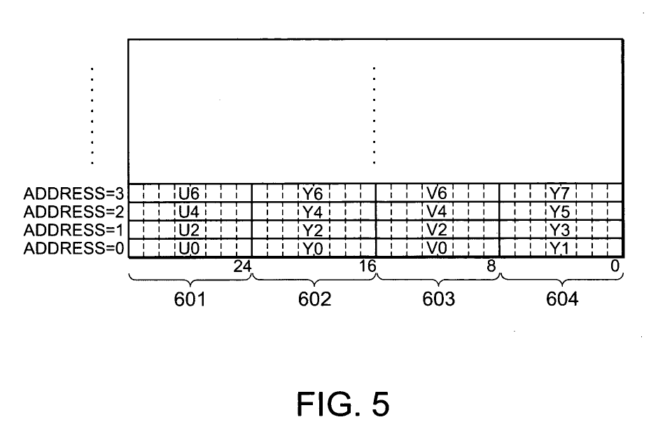

The operation of the camera data transfer system according to the third embodiment will be explained below. In the camera data transfer system according to the present embodiment, the data comparison mask setting register (519) sets mask bits and the data comparator (508) treats the masked bits as ones unintended for comparison in addition to the operation described in the first embodiment. In the case of YUV422 data, for example, the order of inputting data is represented as U0, Y0, V0, Y1, U2, Y2, V2, Y3, . . . . Therefore, when the data comparison mask setting register sets the 8th, 9th and 10th bits and the 24th, 25th and 26th bits in such a manner that they are not intended for comparison where, for example, a bus width is 32 bits, diagonally-shaded portions or sections shown in FIG. 5, i.e., lower 3 bits of color difference data (601, 603) result in ones which are not intended for comparison. In the case of luminance data (602, 604), all of 8 bits are intended for comparison.

Results compared by the data comparator (508) are respectively transmitted to the bus interface circuit (509) every bytes. The bus interface circuit outputs a byte write signal in such a manner that the rewriting of data of only bytes different from one another is performed.

It is generally said that in the case of YUV format data, the slight difference between color difference data (UV) has less influence on human eyes as compared with luminance data (Y). As to the color difference data, only some bits on the MSB side are used for comparison through the use of this characteristic without comparing data of all 8 bits with data of a previous frame, and the byte write signal is outputted from the bus interface circuit to thereby rewrite the data of the frame memory in the LCD display unit into byte groups or units, whereby a reduction in larger power consumption can be expected.

### Fourth Preferred Embodiment

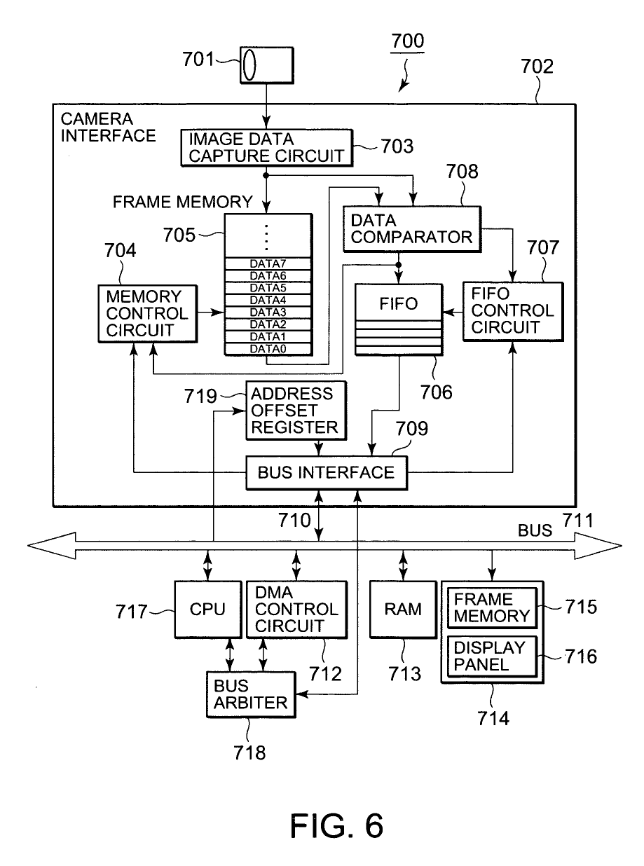

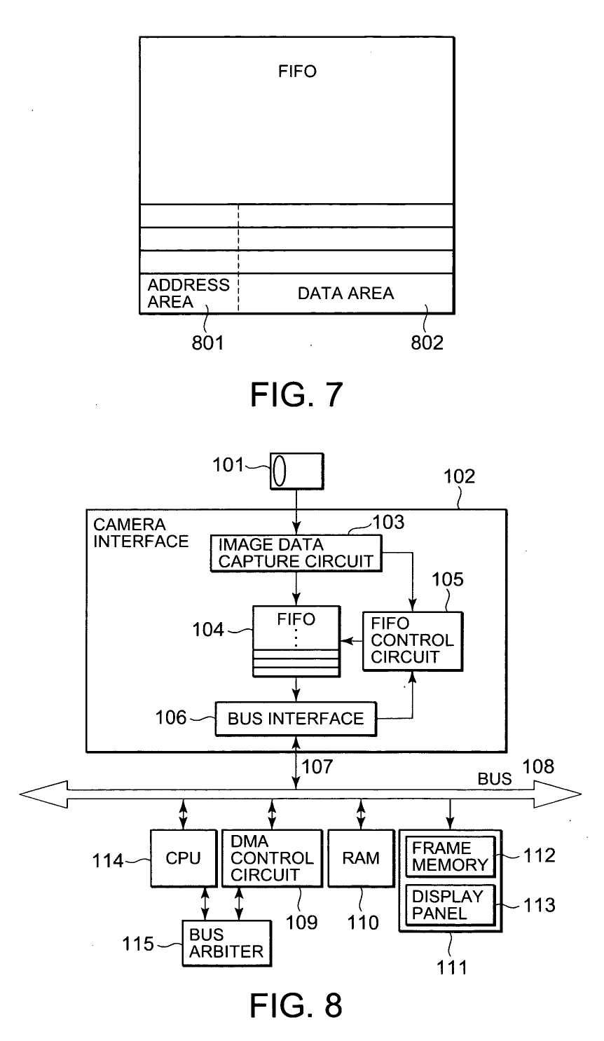

FIG. 6 is a block diagram schematically showing a configuration of a camera data transfer system according to a fourth embodiment of the present invention. In the present camera data transfer system (700), a data comparator (708) inputs therein data outputted from a frame memory (705) and data outputted from an image data capture circuit (703). The outputs of the data comparator are connected to an FIFO (706) and an FIFO control circuit (707), and a memory control circuit (704) respectively. The image data capture circuit also outputs address information indicating to which section in a frame data corresponds, in addition to captured data. A bit configuration of the FIFO (706) takes such a configuration having an address storage area (801) in addition to a data storage area (802) as shown in FIG. 7. An address offset register (719) is configured so as to be capable of setting an offset value for each address on the MSB side via a bus.

The operation of the camera data transfer system according to the present embodiment will be explained below. In comparison with the operation described in the first embodiment, the data stored in the frame memory is compared with its corresponding data outputted from the image data capture circuit. When they are found to coincide with each other from the result of comparison, access to the FIFO and the frame memory is not carried out. On the other hand, when they are found not to coincide with each other, a write enable signal is outputted to the FIFO control circuit (707) and the memory control circuit (704), and address information and image data outputted from the image data capture circuit outputs are written into the FIFO. The address information at this time is used as the LSB side at an address outputted onto the bus. Simultaneously, the rewriting of data at the corresponding place is effected on the frame memory.

The flow of the data stored in the FIFO will next be explained. The data outputted from the FIFO are divided into an address area and a data area. The data in the address area are combined into their corresponding offset values set to the address offset register by means of the bus interface circuit (709), which are used as addresses for the bus. On the other hand, the data in the data area are outputted from a bus control circuit to the bus as data with respect to the addresses.

Since address information is also stored in the FIFO, the data stored in the FIFO can also be outputted collectively to the bus after having reached a given amount. The threshold value of the data amount at this time can be set by, for example, provision of a register within the bus control circuit.

According to the fourth embodiment as described above, the image data outputted from the image data capture circuit are compared with one frame-preceding data stored in the frame memory. Since the data are written into the FIFO together with the address information only when they are found not to coincide, the frequency of access to the FIFO is reduced and hence a further reduction in power consumption can be expected.

Since the address information is also stored in the FIFO, data can also be outputted collectively to the bus after given amounts of data have been stored in the FIFO. Therefore, the bus can efficiently be used inclusive of other masters.

While the preferred forms of the present invention have been described, it is to be understood that modifications will be apparent to those skilled in the art without departing from the spirit of the invention. The scope of the invention is to be determined solely by the following claims.

What is claimed is:

1. A camera data transfer system comprising:
imaging means for generating image data and outputting the same; and
camera interface means including first holding means for holding one frame-preceding image data, second holding means for holding the present image data, comparing means for comparing the contents of the first and second holding means, and bus interface means for controlling the input/output of data to and from a bus,
wherein the data is transferred to a frame memory of display means connected to the bus through the bus interface means to cause the frame memory to display the data thereon, and
wherein when the data held in the first holding means and the data held in the second holding means are found not to coincide with each other as the result of comparison by the comparing means, only a place corresponding to the inconsistent data is transferred to the frame memory of the display means, and the data at the corresponding place of the first holding means is rewritten.

2. The camera data transfer system according to claim 1, wherein the camera interface means is further provided with memory access monitor means and the memory access monitor means compares the number of rewritings for the first holding means with a predetermined threshold value and outputs information corresponding to the result of comparison to the bus.

3. The camera data transfer system according to claim 1, wherein the camera interface means further includes mask setting means, which selects the contents of the first holding means and data to be compared of the second holding means in accordance with mask data set to the mask setting means.

4. The camera data transfer system according to claim 1, wherein the comparing means is means for comparing the contents of the first holding means and the data outputted from the imaging means, and only when inconsistency exists in the data indicative of the result of comparison, the comparing means stores the corresponding inconsistent data and related data in the second holding means.
